(19) United States
(12) Patent Application Publication
(10) Pub. No.: US 2026/0236393 A1
(43) Pub. Date: Aug. 13, 2026

(54) MOBILE DEVICE AND METHOD FOR MAINTAINING STORAGE OF MOBILE DEVICE

(71) Applicant: Samsung Electronics Co., Ltd., Suwon-si (KR)

(72) Inventors: Shicheng Li, Xi'an (CN); Heng Zhang, Xi'an (CN); Yuanyi Zhang, Xi'an (CN); Wenbin Cao, Xi'an (CN); Jinyoung Choi, Suwon-si (KR); Sungjun Park, Suwon-si (KR)

(21) Appl. No.: 19/061,036

(22) Filed: Feb. 24, 2025

(30) Foreign Application Priority Data
Feb. 13, 2025 (CN) 202510160117.4

(51) Int. Cl. G06F 12/02

(52) U.S. Cl. CPC G06F 12/0253; G06F 12/0246; G06F 2212/70

(57) ABSTRACT

Disclosed are a mobile device and a method of maintaining a storage of the mobile device. The method comprises: executing, by at least one processor, computer program instructions to perform operations including: determining a state of a foreground application of the mobile device; and releasing a storage space of the storage based on the state of the foreground application and independently of a state of one or more current background applications of the mobile device.

### TECHNICAL FIELD

The present application relates to a field of data storage, and more particularly, to a mobile device and a method of maintaining a storage of the mobile device.

### BACKGROUND

As the use of a mobile device is increasingly widespread, a technique for efficiently maintaining a storage of the mobile device is increasingly desired. Typically, when maintaining the storage of the mobile device, a space of the storage is reclaimed in a case that input/output (I/O) is idle. However, a process of reclaiming the space of the storage may compete with a foreground application of the mobile device for I/O resources, which may cause delays of data read and write of the foreground application, thereby affecting user experience.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present application provides a mobile device and a method of maintaining a storage device of the mobile device, which can improve user experience while maintaining the storage device.

According to some example embodiments, a method of maintaining a storage device of a mobile device includes: executing, by at least one processor, computer program instructions to perform operations including: determining a state of a foreground application of the mobile device; and releasing a storage space of the storage device based on the state of the foreground application and independently of a state of one or more current background applications of the mobile device.

In the present application, a storage space of the storage is released to maintain the storage based only on the state of the current foreground application, which can avoid the current foreground application from competing with the process of maintaining the storage for I/O resources, so as to improve the user experience. In addition, the present application can perform the process of maintaining the storage more effectively, compared to a scheme of releasing the storage space of the storage based on both a foreground application and background applications.

The releasing of the storage space of the storage comprises: transmitting a current discard request to the storage device based on the state of the current foreground application being determined to be an idle state; and wherein the current discard request comprises at least one discard command configured to invalidate physical addresses of the storage device at which invalid data pages are stored.

In the present application, the discard request is transmitted when the foreground application is idle, so as to avoid the transmission of the discard request from adversely affecting the foreground application.

A number of the at least one discard command of the current discard request is based on a number of discard commands of a previous discard request, and the operations include determining whether a transmission of the previous discard request was interrupted. If the transmission of the previous discard request was interrupted, the number of the at least one discard command of the current discard request is a default value; if the transmission of the previous discard request was not interrupted, the number of the at least one discard command of the current discard request is greater than the number of the discard commands of the previous discard request. When the current discard request is a discard request firstly transmitted among all or a plurality of discard requests, the number of the at least one discard command of the current discard request is the default value.

The at least one discard command of the current discard request is configured to invalidate a maximum number of the physical addresses.

In the present application, the number of discard commands of the current discard request is adjusted based on whether the transmission of the previous discard request was interrupted, so as to improve efficiency of reclaiming the space of the storage device.

The releasing of the storage space of the storage device comprises: based on the state of the current foreground application being determined as an idle state, determining, within a predetermined time interval from a time point at which the state of the current foreground application is determined, whether to transmit an analysis command to the storage device based on a first number of write data pages of the storage device and a second number of invalid data pages of the storage device; determining whether to perform a host initiated defrag (HID) routine in response to transmitting the analysis command; and initiating the host initiated defrag (HID) to transmit a request for a garbage collection operation to the storage device in response to a determination to perform the HID routine.

The determining of whether to transmit the analysis command to the storage device comprises: transmitting the analysis command to the storage device based on the first number being greater than a first threshold or based on the second number being greater than a second threshold, wherein the second number is a sum of a number of first data pages, a number of second data pages, a number of third data pages, and a number of fourth data pages, wherein the first data pages indicate data pages corresponding to a first discard request that has been transmitted to the storage device, wherein the second data pages indicate data pages that are inplace-updated in a user area of the storage device, wherein the third data pages indicate data pages corresponding to a second discard request that will be transmitted to the storage device, wherein the fourth data pages indicate data pages that are inplace-updated in a meta-region of the storage device, and wherein the first threshold is the same as or different from the second threshold.

The determining of whether to perform the HID routine comprises: determining to perform the HID routine based on a number of fragments of the storage device being greater than a third threshold or a number of free blocks of the storage device being less than a fourth threshold.

In the present application, an HID is triggered or initiated automatically when the current foreground application is idle, so as to improve efficiency of reclaiming the space of the storage and to ensure sufficient free space of the storage; in addition, in the present application, the automatically triggered HID is used to release a small storage space, which can avoid excessive data migration from affecting delays of data read and write of the foreground application, so as to improve the user experience.

The determining of the status of the current foreground application of the mobile device comprises: determining the state of the current foreground application as an idle state based on a predetermined time elapsed from a point in time at which the current foreground application transmits a recent request to the storage device for performing a normal operation on the storage, and wherein the normal operation indicates at least one of a read operation and a write operation performed on the storage device.

The storage may include a flash storage device, such as a Universal Flash Storage (UFS).

According to some example embodiments, a mobile device comprises: a storage; and a processor configured to execute computer program instructions that, when executed, cause the processor to determine a state of a foreground application of the mobile device and release a storage space of the storage device based on the state of the foreground application and independently of a state of one or more background applications of the mobile device.

In the present application, a storage space of the storage is released to maintain the storage based only on the state of the current foreground application, which can avoid the current foreground application from competing with the process of maintaining the storage for I/O resources, so as to improve the user experience; in addition, the present application can perform the process of maintaining the storage more effectively, compared to a scheme of releasing the storage space of the storage based on both a foreground application and background applications.

The computer program instructions, when executed, cause the processor to transmit a current discard request to the storage device based on the state of the current foreground application being determined to be an idle state, and wherein the current discard request comprises at least one discard command configured to invalidate physical addresses of the storage device at which invalid data pages are stored.

In the present application, the discard request is transmitted when the foreground application is idle, so as to avoid the transmission of the discard request from adversely affecting the foreground application.

A number of the at least one discard command of the current discard request is based on a number of discard commands of a previous discard request, wherein if transmission of the previous discard request was interrupted, the number of the at least one discard command of the current discard request is a default value, wherein if the transmission of the previous discard request was not interrupted, the number of the at least one discard command of the current discard request is greater than the number of the discard commands of the previous discard request, and wherein based on the current discard request being a discard request firstly transmitted among all discard requests, the number of the at least one discard command of the current discard request is the default value.

The at least one discard command of the current discard request is configured to invalidate a maximum number of the physical addresses.

In the present application, the number of discard commands of the current discard request is adjusted based on whether the transmission of the previous discard request was interrupted, so as to improve efficiency of reclaiming the space of the storage.

The computer program instructions, when executed, cause the processor to: based on the state of the current foreground application being determined as an idle state, determine, within a predetermined time interval from a time point at which the state of the current foreground application is determined, whether to transmit an analysis command to the storage device based on a first number of write data pages and a second number of invalid data pages of the storage device; determine, by the storage device, whether to perform an HID routine in response to transmitting the analysis command; initiate the HID routine to transmit a request for a garbage collection operation to the storage device in response to a determination to perform the HID routine.

The processor is configured to: transmit the analysis command to the storage device based on the first number being greater than a first threshold or based on the second number being greater than a second threshold, wherein the second number is a sum of a number of first data pages, a number of second data pages, a number of third data pages, and a number of fourth data pages, wherein the first data pages indicate data pages corresponding to a discard request that has been transmitted to the storage device, wherein the second data pages indicate data pages that are inplace-updated in a user area of the storage device, wherein the third data pages indicate data pages corresponding to a discard request that will be transmitted to the storage device, wherein the fourth data pages indicate data pages that are inplace-updated in a meta-region of the storage device, and wherein the first threshold is the same as or different from the second threshold.

The computer program instructions, when executed, cause the processor to: determine to perform the HID routine based on a number of fragments of the storage being greater than a third threshold or a number of free blocks of the storage being less than a fourth threshold.

Compared to an HID scheme triggered by a user, in the present application, an HID for releasing a small storage space is triggered automatically when the current foreground application is idle, so as to ensure sufficient free space of the storage device, and to improve efficiency of reclaiming the space of the storage device.

The computer program instructions, when executed, cause the processor to: determine the state of the current foreground application to be an idle state when a predetermined time has elapsed from a point in time at which the current foreground application transmits a recent request for performing a normal operation on the storage to the storage, and wherein the normal operation indicates at least one of a read operation and a write operation performed on the storage device.

The storage may include a flash storage device, such as a Universal Flash Storage (UFS).

The present disclosure provides a mobile device including a flash storage and a processor configured to execute computer program instructions that, when executed, cause the processor to: determine a foreground application of the mobile device is in an idle state when a predetermined time has elapsed from a point in time at which the foreground application transmits a request to perform a read operation or a write operation on the universal flash storage; transmit a current discard request in response to determining that the foreground application is in the idle state; determine whether a previous discard request is present and whether the previous discard request was interrupted; determine a number of a set of discard commands of the current discard request based on a determination of whether the previous discard request is present and a determination of whether the previous discard request was interrupted; and perform, based on the set of discard commands and independently of a state of one or more background applications of the mobile device, a host initiated defrag (HID) routine to release a storage space of the universal flash storage.

According to some example embodiments, there is provided a computer-readable storage medium storing a computer program, when executed by a processor, causes the processor to implement the above method.

Additional aspects and/or advantages of the present disclosure will be partially described in the following description, and part will be clear through the description or may be learn through the practice of various example embodiments.

### BRIEF DESCRIPTION OF THE DRAWINGS

The above and other objects, features and advantages of the present disclosure will become clearer through the following detailed description together with the accompanying drawings in which:

FIG. 1 is a block diagram illustrating a mobile device according to some example embodiments.

FIG. 2 is a flowchart illustrating a method of maintaining a storage of a mobile device according to some example embodiments.

FIG. 3 is a flowchart illustrating a method of releasing a storage space of a storage according to some example embodiments.

FIG. 4 is a flowchart illustrating a method of releasing a storage space of a storage according to some example embodiments.

FIG. 5 is a flowchart illustrating a method of releasing a storage space of a storage according to some example embodiments.

FIG. 6 is a flowchart illustrating a method of determining a status of a current foreground application of a mobile device according to some example embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component (e.g., electrically, physically, and/or communicably connected), the component may be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical or scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. Regarding the reference numerals assigned to the elements in the drawings, it should be noted that the same elements will be designated by the same reference numerals, and redundant descriptions thereof will be omitted.

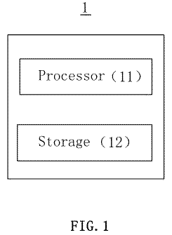

FIG. 1 is a block diagram illustrating a mobile device according to some example embodiments.

The mobile device 1 according to various example embodiments of the present disclosure may include, for example, a mobile phone, a smart phone, a tablet personal computer (PC), a game console, etc. However, embodiments are not limited thereto, and the mobile device 1 according to the present disclosure may be other types of electronic devices.

As is shown in FIG. 1, the mobile device 1 may include a processor 11 and a storage 12.

According to example embodiments, the processor 11 may control overall operations of the mobile device 1. For example, the processor 11 may include a central processing unit (CPU). For example, the processor 11 may include a single processing core or may include a plurality of processing cores (multi-core). The processor 11 may process or execute programs and/or data stored in the storage 12. For example, the processor 11 may control the mobile device 1 to execute an application stored thereon.

According to example embodiments, the storage 12 may include a non-volatile memory device. For example, the storage 12 may include a storage device (e.g., Universal Flash Storage (UFS)) that supports host initiated defrag routines (HID). However, examples are not limited thereto, and the storage 12 may include other storage devices.

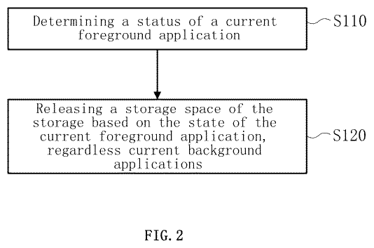

FIG. 2 is a flowchart illustrating a method of maintaining a storage of a mobile device according to some example embodiments.

As shown in FIG. 2, in operation S110, the processor 11 may determine a status of a current foreground application (e.g., a foreground application at a current time) of the mobile device 1.

According to example embodiments, the current foreground application of the mobile device 1 may be an application that performs operations based on user interactions with the mobile device 1, such as a gaming application or a messaging application. For example, when the mobile device 1 is not locked, the current foreground application of the mobile device 1 may be an application displayed by a screen of the mobile device 1; and when the mobile device 1 is locked, the current foreground application of the mobile device 1 may be an application displayed by the screen before the mobile device 1 is locked. According to example embodiments, a number of the current foreground application of the mobile device 1 may be one or more.

In operation S120, the processor 11 may release a storage space of the storage 12 based on the state of the current foreground application regardless or independently of a state of a current background applications of the mobile device 1. As used herein, a “background application” that performs operations independently of or without user interactions with the mobile device 1, such as applications for updating the operating system.

According to example embodiments, the processor 11 may release the storage space of the storage 12 based on the state of the current foreground application being determined as an idle state. Releasing the storage space includes, but is not limited to, deleting cached data and/or temporary files, offloading unused or unnecessary data, and deallocating unused data structures, among other known storage space releasing operations.

According to example embodiments, the processor 11 may determine the state of the current foreground application as the idle state when a predetermined time has elapsed from a point in time at which the current foreground application transmits a recent (or final) request for performing a normal operation on the storage 12 to the storage 12.

For example, the normal operation may indicate at least one of a read operation and a write operation performed on the storage 12.

According to another embodiment, the processor 11 may also release the storage space of the storage 12 based on whether the storage 12 is in the idle state.

For example, the processor 11 may determine whether the storage 12 is in the idle state based on a number of discard commands (e.g., commands to release the storage space of the storage) that will be transmitted to the storage 12 and discard commands that have been transmitted to the storage 12 but have not been processed by the storage 12.

In the present application, a storage space of the storage is released to maintain the storage based only on the state of the current foreground application, which can avoid the current foreground application from competing with the process of maintaining the storage for I/O resources, so as to improve the user experience; in addition, the present application can perform the process of maintaining the storage more effectively, compared to a scheme of releasing the storage space of the storage based on both a foreground application and background applications.

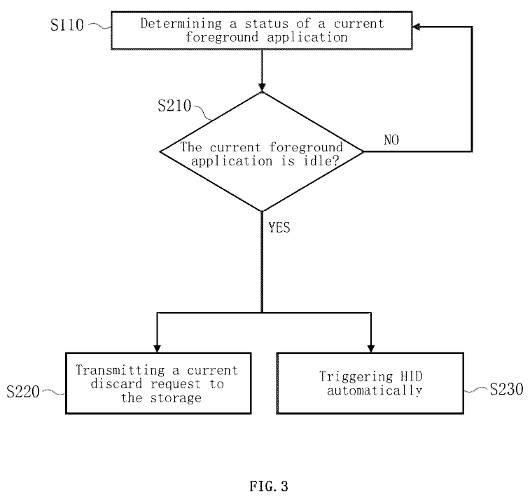

FIG. 3 is a flowchart illustrating a method of releasing a storage space of a storage according to some example embodiments.

As shown in FIG. 3, in operation S210, the processor 11 may determine whether the state of the current foreground application is the idle state.

When the state of the current foreground application is determined as the idle state (YES in operation S210), in operation S220, the processor 11 may transmit a current discard request to the storage 12, so as to invalidate at least one of physical addresses, at which invalid data pages are stored, of the storage 12.

According to example embodiments, the current discard request may include at least one discard command in a set of discard commands (e.g., a set of current discard commands) for invalidating physical addresses, at which invalid data pages (e.g., current invalid data pages) are stored, of the storage 12.

According to example embodiments, the processor 11 may determine a number of the at least one discard command of the current discard request based on a number of discard commands of a previous discard request.

For example, the previous discard request may indicate a discard request transmitted to the storage 12 before transmitting the current discard request (e.g., when a previous foreground application is idle). According to example embodiments, the previous foreground application may be an application which is the same as or different from the current foreground application.

According to example embodiments, if transmission of the previous discard request was interrupted, the number of the at least one discard command of the current discard request is a default value; and if the transmission of the previous discard request was not interrupted, the number of the at least one discard command of the current discard request is greater than the number of the discard commands of the previous discard request. When the current discard request is a discard request firstly transmitted among all discard requests, the number of the at least one discard command of the current discard request is the default value.

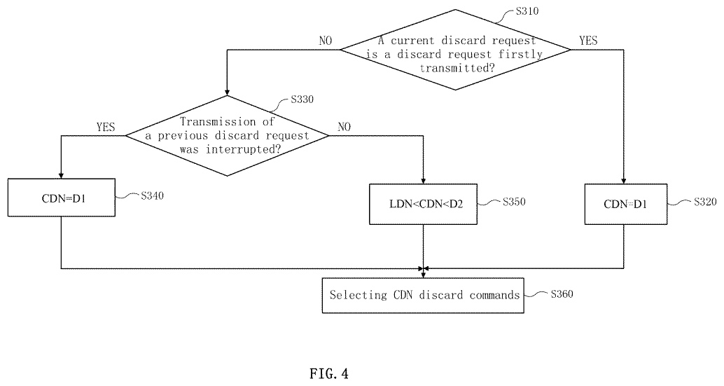

For example, the at least one discard command of the current discard request is at least one discard command, which invalidates a maximum number of the physical addresses, among the set of discard commands. The process of transmitting the discard request will be described in detail with reference to FIG. 4.

In addition, when the state of the current foreground application is determined as the idle state (YES in operation S210), in operation S230, the processor 11 may trigger the host initiated defrag routine (HID) for releasing the storage space, which is smaller than a predetermined size (e.g., 4 GB, but not limited thereto), of the storage 12.

According to example embodiments, the processor 11 may determine whether to transmit an analysis command to the storage 12, based on a first number of write data pages and a second number of invalid data pages of the storage within a predetermined time interval from a time point at which the state of the current foreground application is determined (e.g., within a predetermined time interval before or after the time point at which the state of the current foreground application is determined).

For example, the processor 11 may transmit the analysis command to the storage 12 based on the first number being greater than a first threshold or based on the second number being greater than a second threshold. For example, the second number may be a sum of a number of first data pages, a number of second data pages, a number of third data pages, and a number of fourth data pages. For example, the first data pages may indicate data pages (e.g., invalid data pages) corresponding to a discard request that has been transmitted to the storage 12; the second data pages may indicate data pages that are inplace-updated in a user area of the storage 12 (e.g., data pages that are updated in its current location of the storage 12 as opposed to recreating and saving a version of the data pages in another location of the storage 12); the third data pages may indicate data pages (e.g., invalid data pages) corresponding to a discard request that will be transmitted to the storage 12; and the fourth data pages may indicate data pages that are inplace-updated in a meta-region of the storage 12. In an example, the first threshold is the same as or different from the second threshold.

According to example embodiments, when the analysis command is transmitted to the storage 12, the storage 12 may determine whether to perform the defrag routine in response to the analysis command.

According to example embodiments, the storage 12 may determine to perform the defrag routine based on a number of fragments of the storage 12 being greater than a third threshold or a number of free blocks of the storage 12 being less than a fourth threshold.

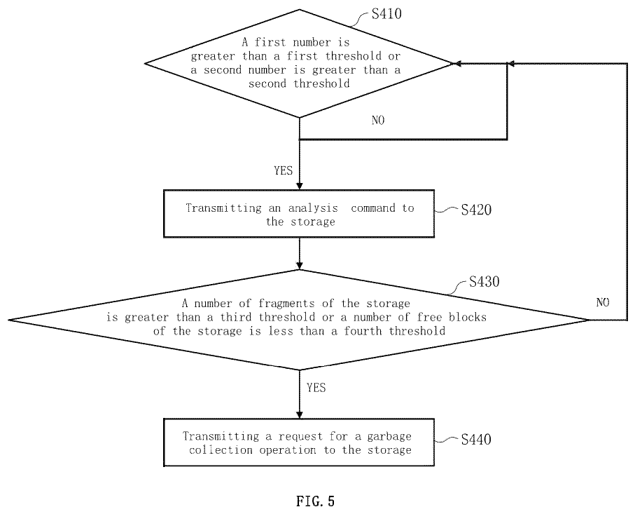

According to example embodiments, the processor 11 may trigger or initiate the HID to transmit a request for a garbage collection operation to the storage 12, so as to release the storage space, which is smaller than a predetermined size, of the storage 12 when determining to perform the defrag. The process of performing HID will be described in detail with reference to FIG. 5.

When the state of the current foreground application is determined as a busy state (NO in operation S210), the process may proceed to operation S110.

According to example embodiments, the processor 11 may perform operations S220 and S230 in parallel or sequentially, or the processor 11 may only perform one of operations S220 and S230.

In the present application, the discard request is transmitted when the foreground application is idle, so as to avoid the transmission of the discard request from adversely affecting the foreground application. In the present application, the number of discard commands of the current discard request is adjusted based on whether the transmission of the previous discard request was interrupted, so as to improve efficiency of reclaiming the space of the storage.

In the present application, an HID is triggered or initiated automatically when the current foreground application is idle, so as to improve efficiency of reclaiming the space of the storage and to ensure sufficient free space of the storage; in addition, in the present application, the automatically triggered/initiated HID is used to release a small storage space, which can avoid excessive data migration from affecting delays of data read and write of the foreground application, so as to improve the user experience.

FIG. 4 is a flowchart illustrating a method of releasing a storage space of a storage according to some example embodiments.

As shown in FIG. 4, in operation S310, the processor 11 may determine whether a current discard request CDQ is a discard request firstly transmitted.

When the current discard request CDQ is the discard request firstly transmitted (YES in operation S310), in operation S320, the processor 11 may determine a number CDN of discard commands of the current discard request CDQ to be a first default value D1 (e.g., D1 is an integer greater than 1).

When the current discard request CDQ is not the discard request firstly transmitted (NO in operation S310), in operation S330, the processor 11 may determine whether transmission of a previous discard request LDQ was interrupted.

When the transmission of the previous discard request LDQ was interrupted (YES in operation S330), in operation S340, the processor 11 may determine the number CDN of the discard commands of the current discard request CDQ to be the first default value D1.

When the transmission of the previous discard request LDQ was not interrupted (NO in operation S330), in operation S350, the processor 11 may determine the number CDN of the discard commands of the current discard request CDQ to be greater than a number LDN of discard commands of the previous discard request LDQ and smaller than a second default value D2 (e.g., D2 is an integer greater than D1).

In operation S360, the processor 11 may select the number CDN of discard commands, which invalidate a maximum number of the physical addresses (e.g., top CDN discard commands that invalidate the maximum number of the physical addresses), from among the set of discard commands.

FIG. 5 is a flowchart illustrating a method of releasing a storage space of a storage according to some example embodiments.

As shown in FIG. 5, in operation S410, the processor 11 may determine whether a first number of write data pages of the storage 12 within a predetermined time interval from a time point at which the state of the current foreground application is determined is greater than a first threshold, or whether a second number of invalid data pages of the storage 12 within the predetermined time interval is determined is greater than a second threshold.

When the first number is smaller than or equal to the first threshold and the second number is smaller than or equal to the second threshold (NO in operation S410), the process may proceed to operation S410.

When the first number is greater than the first threshold or the second number is greater than the second threshold (YES in operation S410), in operation S420, the processor 11 may transmit an analysis command to the storage 12.

In operation S430, the storage 12 may determine whether a number of fragments of the storage 12 is greater than a third threshold or a number of free blocks of the storage 12 is less than a fourth threshold based on or in response to the analysis command.

When the number of the fragments of the storage 12 is smaller than or equal to the third threshold and the number of the free blocks of the storage 12 is smaller than or equal to the fourth threshold (NO in operation S 430), the process may proceed to operation S410.

When the number of the fragments of the storage 12 is greater than the third threshold or the number of the free blocks of the storage 12 is less than the fourth threshold (YES in operation S430), in operation S440, the processor 11 may determine to perform the defrag routine, (e.g., to trigger or initiate HID), and to transmit a request for a garbage collection operation to the storage 12, which is performed on the storage space, which is small (e.g., is smaller than a predetermined size), of the storage 12.

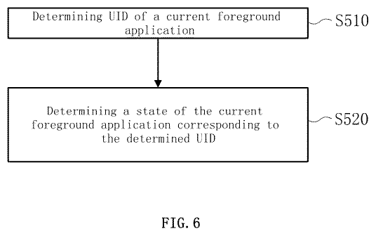

FIG. 6 is a flowchart illustrating a method of determining a status of a current foreground application of a mobile device according to some example embodiments.

As shown in FIG. 6, in operation S510, the processor 11 may determine a user identity (UID) of a current foreground application.

According to example embodiments, the processor 11 may determine the UID of the current foreground application using a java native interface (JNI) method and a system call (Syscall) method.

For example, the UID of the current foreground application may be transferred to the processor 11 (e.g., a kernel of the processor 11) by the JNI method and the Syscall method.

However, examples are not limited thereto, and other known methods can also be used to determine the UID of the current foreground application.

In operation S520, the processor 11 may determine a state of the current foreground application corresponding to the determined UID.

For example, the processor 11 may determine the state of the current foreground application as an idle state, when a predetermined time has elapsed from a point in time at which the current foreground application transmits a recent (or final) request for performing a normal operation on the storage 12 to the storage 12.

The apparatuses, units, modules, devices, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In an example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples plurality of processors or computers may be used, or a processor or computer may include plurality of processing elements, or plurality of types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction plurality of-data (SIMD) multiprocessing, plurality of-instruction single-data (MISD) multiprocessing, and plurality of-instruction plurality of-data (MIMD) multiprocessing.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In an example, the instructions or software include machine code that is directly executed by the processor or computer, such as machine code produced by a compiler. In another example, the instructions or software include higher-level code that is executed by the processor or computer using an interpreter. Programmers of ordinary skill in the art may readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above (e.g., as illustrated in the above flowcharts and/or block diagram blocks), and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer may execute the instructions.

The present disclosure has been described herein with reference to flowchart and/or block diagram illustrations of methods, systems, and devices in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, are configured to implement the functions specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

While this disclosure includes specific examples, it will be apparent to one of ordinary skill in the art that various changes in form and details may be made in these examples without departing from the scope of the claims and their equivalents.

1. A method of maintaining a storage device of a mobile device comprising:
executing, by at least one processor, computer program instructions to perform operations comprising:
determining a state of a foreground application of the mobile device; and
releasing a storage space of the storage device based on the state of the foreground application while the foreground application remains a foreground application and independently of a state of one or more background applications of the mobile device.

2. The method of claim 1, wherein:
the releasing of the storage space of the storage device further comprises: transmitting a current discard request to the storage device when the state of the foreground application is determined to be an idle state; and
the current discard request comprises at least one discard command configured to invalidate physical addresses of the storage device at which invalid data pages are stored.

3. The method of claim 2, wherein:
when a previous discard request has occurred, a number of the at least one discard command of the current discard request is based on a number of discard commands of [[a]]the previous discard request.

4. The method of claim 3, wherein:
the operations comprise determining whether a transmission of the previous discard request was interrupted, and
in response to a determination that the transmission of the previous discard request was interrupted, the number of the at least one discard command of the current discard request is a default value.

5. The method of claim 3, wherein:
the operations comprise determining whether a transmission of the previous discard request was interrupted, and
in response to a determination that the transmission of the previous discard request was not interrupted, the number of the at least one discard command of the current discard request is greater than the number of the discard commands of the previous discard request.

6. The method of claim 3, wherein when the current discard request is a discard request firstly transmitted among a plurality of discard requests, the number of the at least one discard command of the current discard request is a default value.

7. The method of claim 3, wherein the at least one discard command of the current discard request is configured to invalidate a maximum number of the physical addresses among discard commands of the current discard request.

8. The method of claim 1, wherein the releasing of the storage space of the storage device comprises: when the state of the foreground application is determined to be an idle state:
Determining, within a predetermined time interval from a time point at which the state of the foreground application is determined, whether to transmit an analysis command to the storage device based on a first number of write data pages of the storage device and a second number of invalid data pages of the storage device;
determining whether to perform a host initiated defrag (HID) routine in response to transmitting the analysis command; and
initiating the HID routine to transmit a request for a garbage collection operation to the storage device in response to a determination to perform the HID routine.

9. The method of claim 8, wherein:
the determining of whether to transmit the analysis command to the storage device comprises transmitting the analysis command to the storage device when the first number is greater than a first threshold or when the second number is greater than a second threshold,
the second number is a sum of a number of first data pages, a number of second data pages, a number of third data pages, and a number of fourth data pages,
the first data pages indicate data pages corresponding to a first discard request that has been transmitted to the storage device,
the second data pages indicate data pages that are inplace-updated in a user area of the storage device,
the third data pages indicate data pages corresponding to a second discard request that will be transmitted to the storage device, and
the fourth data pages indicate data pages that are inplace-updated in a meta-region of the storage device.

10. The method of claim 8, wherein the determining of whether to perform the HID routine comprises: determining to perform the HID routine when a number of fragments of the storage device is greater than a third threshold or a number of free blocks of the storage device is less than a fourth threshold.

11. The method of claim 1, wherein the determining of the state of the foreground application of the mobile device comprises:
determining the state of the foreground application to be an idle state when a predetermined time has elapsed from a point in time at which the foreground application transmits a request to the storage device for performing a normal operation on the storage,
wherein the normal operation indicates at least one of a read operation and a write operation performed on the storage device.

12. A mobile device comprising:
a storage device; and
a processor configured to execute computer program instructions that, when executed, cause the processor to determine a state of a foreground application of the mobile device and release a storage space of the storage device based on the state of the foreground application while the foreground application remains a foreground application and independently of a state of one or more background applications of the mobile device.

13. The mobile device of claim 12, wherein:
the computer program instructions, when executed, cause the processor to transmit a current discard request to the storage device when the state of the foreground application is determined to be an idle state,
the current discard request comprises at least one discard command configured to invalidate physical addresses of the storage device at which invalid data pages are stored,
a number of the at least one discard command of the current discard request is based on a number of discard commands of a previous discard request,
the computer program instructions, when executed, cause the processor to determine whether a transmission of the previous discard request was interrupted, and
in response to a determination that the transmission of the previous discard request was interrupted, the number of the at least one discard command of the current discard request is a default value.

14. The mobile device of claim 12, wherein:
the computer program instructions, when executed, cause the processor to transmit a current discard request to the storage device when the state of the foreground application is determined to be an idle state,
the current discard request comprises at least one discard command configured to invalidate physical addresses of the storage device at which invalid data pages are stored,
a number of the at least one discard command of the current discard request is based on a number of discard commands of a previous discard request,
the computer program instructions, when executed, cause the processor to determine whether a transmission of the previous discard request was interrupted, and
in response to a determination that the transmission of the previous discard request was not interrupted, the number of the at least one discard command of the current discard request is greater than the number of the discard commands of the previous discard request.

15. The mobile device of claim 12, wherein:
the computer program instructions, when executed, cause the processor to transmit a current discard request to the storage device when the state of the foreground application is determined to be an idle state,
the current discard request comprises at least one discard command configured to invalidate physical addresses of the storage device at which invalid data pages are stored, a number of the at least one discard command of the current discard request is based on a number of discard commands of a previous discard request,
when the current discard request is a discard request firstly transmitted among a plurality of discard requests, the number of the at least one discard command of the current discard request is a default value.

16. The mobile device of claim 12, wherein the computer program instructions, when executed, cause the processor to: when the state of the foreground application is determined to be an idle state,
determine, within a predetermined time interval from a time point at which the state of the foreground application is determined, whether to transmit an analysis command to the storage device based on a first number of write data pages and a second number of invalid data pages of the storage device;
determine whether to perform a host initiated defrag (HID) routine in response to transmitting the analysis command; and
initiating the HID routine to transmit a request for a garbage collection operation to the storage device in response to a determination to perform the HID routine.

17. The mobile device of claim 16, wherein:
the computer program instructions, when executed, cause the processor to transmit the analysis command to the storage device when the first number is greater than a first threshold or when the second number is greater than a second threshold,
the second number is a sum of a number of first data pages, a number of second data pages, a number of third data pages, and a number of fourth data pages,
the first data pages indicate data pages corresponding to a first discard request that has been transmitted to the storage device,
the second data pages indicate data pages that are inplace-updated in a user area of the storage device,
the third data pages indicate data pages corresponding to a second discard request that will be transmitted to the storage device, and
the fourth data pages indicate data pages that are inplace-updated in a meta-region of the storage device

18. The mobile device of claim 17, wherein the computer program instructions, when executed, cause the processor to determine to perform the HID routine when a number of fragments of the storage device is greater than a third threshold or a number of free blocks of the storage device is less than a fourth threshold.

19. The mobile device of claim 12, wherein the computer program instructions, when executed, cause the processor to determine the state of the foreground application to be an idle state when a predetermined time has elapsed from a point in time at which the foreground application transmits a request to the storage device for performing a normal operation on the storage device, and
wherein the normal operation indicates at least one of a read operation and a write operation performed on the storage device.

20. A mobile device comprising:
a flash storage device; and
a processor configured to execute computer program instructions that, when executed, cause the processor to:
determine a foreground application of the mobile device is in an idle state when a predetermined time has elapsed from a point in time at which the foreground application transmits a request to perform a read operation or a write operation on the flash storage device;
transmit a current discard request in response to determining that the foreground application is in the idle state;
determine whether a previous discard request is present and whether the previous discard request was interrupted;
determine a number of a set of discard commands of the current discard request based on a determination of whether the previous discard request is present and a determination of whether the previous discard request was interrupted; and
perform, based on the set of discard commands and independently of a state of one or more background applications of the mobile device, a host initiated defrag (HID) routine to release a storage space of the flash storage device.
